(19) United States
(12) Patent Application Publication
(10) Pub. No.: US 2005/0085245 A1
(43) Pub. Date: Apr. 21, 2005

(54) Wake of computer system on reception of short message service (SMS)

(76) Inventor: Gunner D. Danneels, Beaverton, OR (US)

Correspondence Address: INTEL CORPORATION, P.O. BOX 5326, SANTA CLARA, CA, 95056-5326, US

(21) Appl. No.: 10/686,446

(22) Filed: Oct. 15, 2003

(51) Int. Cl. H04M 3/00; H04Q 7/20; H04M 1/00; H04B 1/38

(52) U.S. Cl. 455/466; 455/574; 455/420

(57) ABSTRACT

Apparatus and methods are provided to enable a wireless wide area network (WWAN) module to filter WWAN signals and to determine whether to awaken a processor from a low power mode. When it is determined that the processor is not to be awakened, the WWAN signals may be stored for subsequent processing, and the processor may maintain the low power mode.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

Embodiments of the present invention relate generally to the field of data communications, and more particularly relating to communications involving short message service (SMS).

### BACKGROUND

Computer systems, especially mobile computer systems, are becoming ever more popular today. Typically, mobile computer systems have a clam-shell form factor such that when a lid is open, a display and a keyboard are exposed. The user may power on the computer system and start an operating system (OS). The user may then initiate one or more applications such as, for example, electronic mail (email), appointment calendar, addresses book, etc. The computer system may need to be connected to a local area network (LAN) to receive up-to-date information.

In the fast pace of today society, it is becoming more important for the user to be able to receive information while on the go. With the compact design of mobile computer systems and the acceptance of wireless communications, the user may no longer have to be constrained to an office to get the information. For example, a user who is traveling may be able to connect to an access point (normally referred to as a hot spot) to read email messages, calendar appointments, etc. When the user needs to be connected to a network more continuously, the user may connect via a wireless wide area network (WWAN), which is available almost ubiquitously.

Because the mobile computer systems normally rely on batteries as a power source, different power-saving techniques have been developed to reduce power consumption and to extend life of the system battery. This may include, for example, placing a system processor into different low power modes. This may also include powering off the mobile computer system. In these situations, the mobile computer system may not be able to connect to or receive data from a network.

It may be possible that during the time that the mobile computer system is in the low power mode, the user may continue to receive information. The information may or may not be important, but the user has no knowledge of this until the mobile computer system is in a normal power mode and a connection to a network (wireless or wired) is established. This may prevent the user from getting up-to-date information in a timely manner.

Short message service (SMS) is a mechanism of delivery of short messages between mobile devices over the wireless networks. A text message from a source may be stored in a central short message center (SMC) which then forwards the text message to a destination (e.g., a mobile computer system). When the destination is not available, the message may be stored and may later be forwarded when the destination becomes available. Each SMS message may be no longer than 160 characters. Technologies are available today to enable sending SMS messages from handheld devices using the wireless networks and from computer systems connected to a wired network.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates an example of a network diagram, in accordance with one embodiment.

FIG. 2 is a block diagram illustrating one example of a computer system, in accordance with one embodiment.

FIG. 3 is a block diagram illustrating an example of the computer system with one or more communications modules, in accordance with one embodiment.

FIG. 4 is a block diagram illustrating filtering of WWAN signals to determine whether to awaken the processor, in accordance with one embodiment.

FIG. 5 is a flow diagram illustrating one example of a process that monitors for WWAN signals, in accordance with one embodiment.

FIG. 6 is another flow diagram illustrating one example of a process that monitors for and filter SMS messages, in accordance with one embodiment.

### DETAILED DESCRIPTION

For one embodiment, WWAN signals are received by a computer system when a processor in the computer system is in a low power mode. The WWAN signals may be filtered to determine if actions are to be performed. The processor may be awakened to perform the actions.

In the following description, for purposes of explanation, numerous specific details are set forth in order to provide a thorough understanding of the present invention. It will be evident, however, to one skilled in the art that the present invention may be practiced without these specific details. In other instances, well-known structures, processes and devices are shown in block diagram form or are referred to in a summary manner in order to provide an explanation without undue detail.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur.

Reference in the specification to “one embodiment” or “an embodiment” of the present invention means that a particular feature, structure or characteristic described in connection with the embodiment is included in at least one embodiment of the present invention. Thus, the appearances of the phrase “for one embodiment” or “in accordance with one embodiment” appearing in various places throughout the specification are not necessarily all referring to the same embodiment.

Network

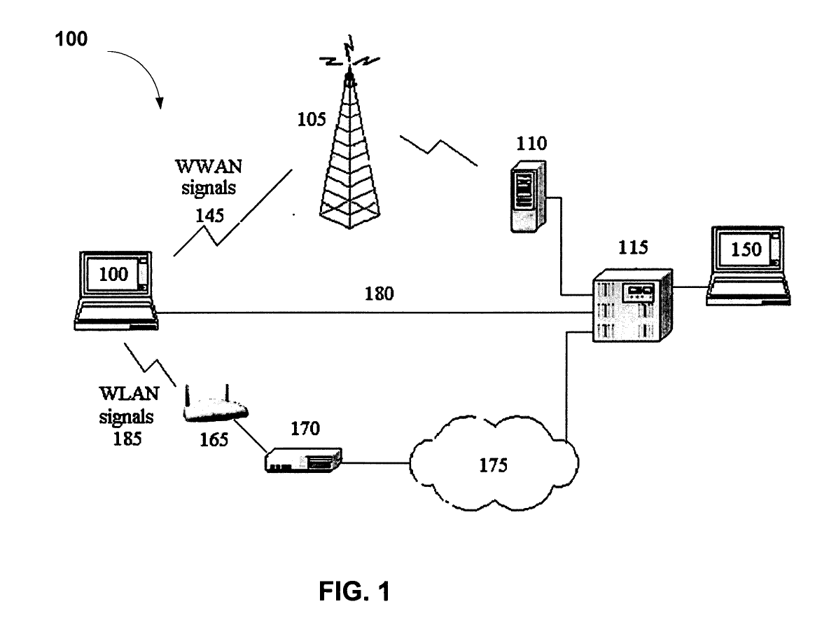

FIG. 1 illustrates an example of a network diagram, in accordance with one embodiment. Network 100 may include computer system 100. A WWAN module (not shown) in the computer system 100 may enable sending and receiving WWAN signals 145 via a cellular tower 105 and a base station (BS) 110. The BS 110 may include base station controllers (BSC) and the base transceiver stations (BTS) (also known as cells). The BSC may control one or more BTSs and is in charge of the proper resource assignment when a subscriber moves around.

The host computer system 115 may be, for example, an enterprise mainframe computer system or a server computer system. The host computer system 115 may provide services to multiple computer systems including computer system 100 and computer system 150. The host computer system 115 may associate the computer system 100 with a unique identification. For example, a unique network address may be assigned by a WWAN service provider (e.g., AT&T, T-mobile, etc.) to the computer system 100, and this unique network address may be used by the WWAN service provider to transport information sent by the host computer system 115 to the computer system 100. Although not shown, one skilled in the art may recognize that other network components such as, for example, a Serving GPRS Support Node (SGSN), a Gateway GPRS Support Node (GGSN), may also be used to establish a WWAN GPRS connection.

For one embodiment, the computer system 100 may also include a WLAN module (not shown) to enable sending and receiving WLAN signals 185 via an access point (AP) 165 (also known as a hotspot), and an authentication, authorization and accounting (AAA) server 170. The WLAN signals 185 may include information sent from the host computer system 215. The AAA server 170 may perform various functions that may include, for example, gathering accounting information for billing purposes. The AAA server 170 may include gateway functions to connect the computer system 100 to an external network 175 such as, for example, the Internet. The AAA server 170 may allocate IP address to the computer system 100 and may maintain a list of authenticated devices' IP addresses. Although not shown, one skilled in the art may recognize that other WLAN network components may also be used to establish a WLAN connection. For one embodiment, the computer system 100 may also include a wired network module (not shown) to establish a wired connection 180 to the host computer system 215.

In the following descriptions, SMS messages may be used as examples of WWAN signals 145; however, one skilled in the art will recognize that other types of WWAN signals may also be used. When the WWAN signals 145 include SMS messages, the network 100 may include a SMS Center (SMSC) (not shown). The SMSC may be responsible for relaying, storing and forwarding SMS messages to and from the computer system 100.

Computer System

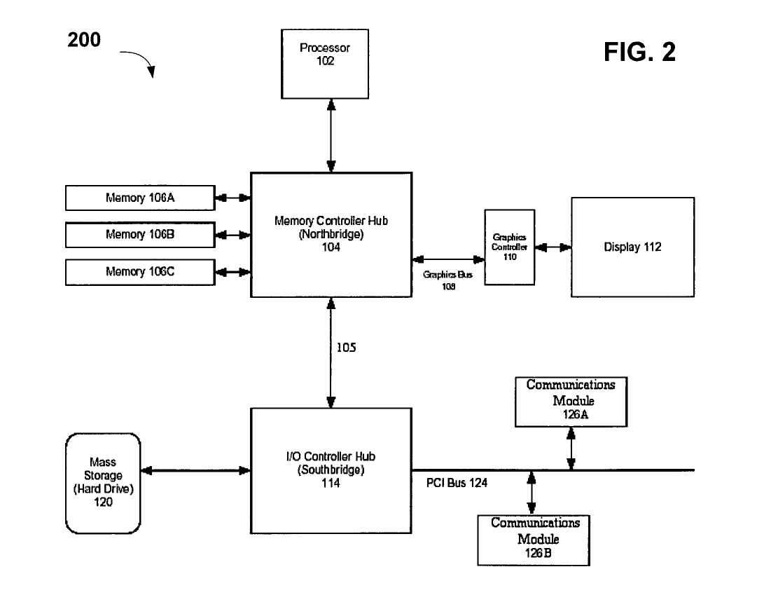

FIG. 2 is a block diagram illustrating one example of a computer system, in accordance with one embodiment. Computer system 100 may be a mobile computer system and may include processor 102, memory controller hub 104 (also known as Northbridge), and I/O controller hub 114 (also known as Southbridge). The processor 102 may be a high-performance processor such as, for example, a processor in the family of Pentium processors manufactured by Intel Corporation of Santa Clara, Calif. Other processors may also be used. The memory controller hub 104 may connect to memory system 106(A-C) which may be a combination of one or more static random access memory (SRAM), dynamic random access memory (DRAM), read only memory (ROM), etc. The memory controller hub 104 may be coupled to a graphics controller 110. Although the graphics controller 110 is illustrated as a separate component from the memory controller hub 104, the graphics controller logic may be included in the memory controller hub 104. Display 112 may be connected to the graphics controller 110 and to the memory controller hub 104 via a high-speed graphics bus 108 such as, for example, an Accelerated Graphics Port (AGP) bus. The display 112 may be a liquid crystal display (LCD) or other suitable display technology.

The input/output (I/O) controller hub 114 may be connected to the memory controller hub 104 by connection 105. The I/O controller hub 114 controls the operation of mass storage 120 such as, for example, a hard drive. The I/O controller hub 114 may also control I/O buses such as, for example, and Peripheral Component Interconnect (PCI) bus 124. The PCI bus 124 may be used to connect one or more communications modules. For example, communications modules 126A-B may include a wireless wide area network (WWAN) module, a wireless local area network (WLAN) module, a wired network module (e.g., an Ethernet module), etc. The communications module may be in different forms. For example, the WLAN module may be an USB 802.11 adapter, a mini-PCI or PC card, etc., and the WWAN module may be a PC card, a Universal Serial Bus (USB) device, an embedded module, etc.

Normally-On WWAN Module

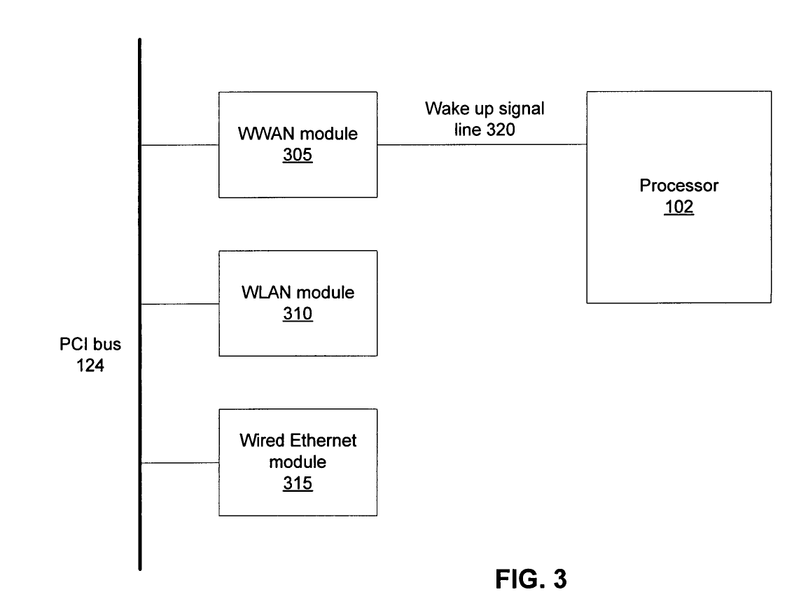

FIG. 3 is a block diagram illustrating an example of the computer system 100 with one or more communications modules, in accordance with one embodiment. The computer system 100 in this example may include WWAN module 305. Although not shown, the WWAN module 305 may include an antenna to receive WWAN signals. Furthermore, although not necessary for some embodiments of the present invention, the computer system 100 may also include WLAN module 310 and Wired Ethernet module 315. In this example, these communications modules are connected to the PCI bus 124.

To reduce power consumption, there may be situations when the computer system 100 is placed in a low power mode (e.g., standby mode or sleep mode). In the low power mode, one or more components (e.g., the processor 102, the memory system 106A-C, the hard drive 120, the WWAN module 305, the WLAN module 310, the wired Ethernet module 315, etc.) may be powered off or may operate in the low power mode. When a component is powered off or in the low power mode, it may not be able to perform functions as it normally can when it is in the normal power mode. For example, when the WWAN module 305 is powered off, it may not be able to receive SMS messages sent to the computer system 100. Similarly, when the processor 102 is in the low power mode, it may not be able to process the SMS messages.

For one embodiment, the WWAN module 305 may maintain its normal power mode while the computer system 100 is in the low power mode. For another embodiment, the WWAN module 305 may maintain its normal power mode regardless of the operating mode of the computer system 100. The WWAN module 305 may include its own dedicated battery. Alternatively, the WWAN module 305 may have a connection to draw power from a power source (e.g., battery) that provides power to the processor 102. This may enable the WWAN module 305 to continuously monitor and receive the SMS messages.

Processor Wakeup Signal

For one embodiment, a connection may be established between the WWAN module 305 and the processor 102. This connection is illustrated in the example in FIG. 3 as signal line 320, which may be a direct line or an indirect line. The signal line 320 may be used by the WWAN module 305 to awaken the processor 102 when the processor 102 is in the low power mode. This may include transitioning the processor 102 from the low power mode to a normal power mode. It may be noted that awakening the processor 102 may also cause one or more other components to return to their normal power modes. It may also be noted that in certain situations, it may not be possible to awaken the processor 102. For example, when the computer system 100 is in the standby mode, the processor 102 may be almost powered off, but it may be awakened to return to the normal power mode. However, when the computer system 100 is in a hibernate mode, all components in the computer system 100, including the processor 102, are essentially powered off, and it may not be possible to awaken the processor 102.

Filter Policy

The host computer system 215 may include mail server functions to store emails associated with different email accounts, including an email account associated with the computer system 100. For one embodiment, when an email is received in the email account associated with the computer system 100, an SMS message is generated and sent to the computer system 100. The SMS message may relate to information included in the email and may be received by the WWAN module 305. The WWAN module 305 may then forward the SMS message to the processor 102 for processing. For example, the processor 102 may cause the SMS messages to be displayed on the display 112.

Over time, the WWAN module 305 may receive a large number of SMS messages. Some of these SMS messages may be important, and some may not be as important. For one embodiment, when the processor 102 is in the low power mode, the WWAN module 305 may awaken the processor 102 whenever the WWAN module 305 receives an SMS message. However, awakening the processor 102 whenever the WWAN module 305 receives an SMS message may reduce the time that the processor 102 can be in the low power mode.

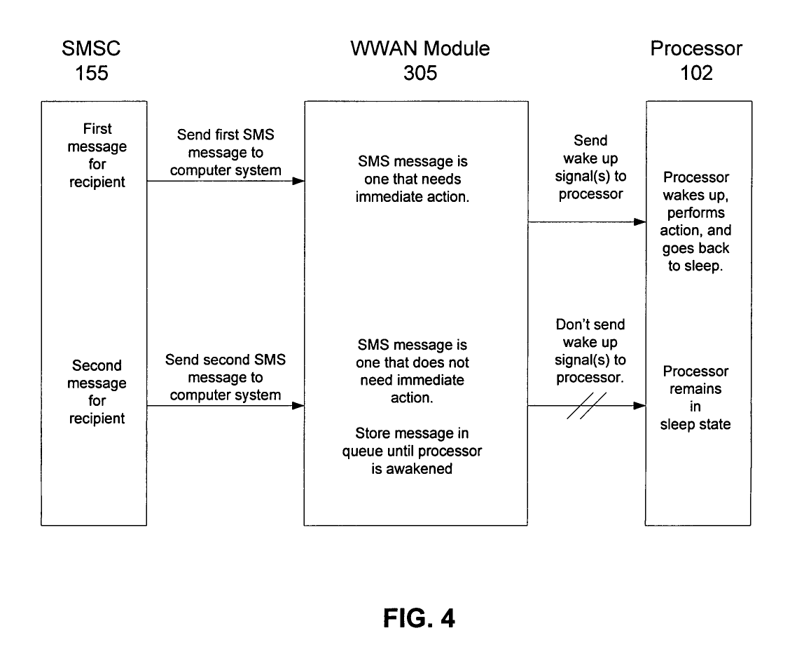

A policy may be used to determine when the WWAN module 305 may awaken the processor 102. The WWAN module 305 may include WWAN handling logic (implemented in software, hardware, or both) to filter the SMS messages based on the policy. For one embodiment, when the policy indicates to the WWAN handling logic that the SMS message may require the processor 102 to perform some actions that cannot be delayed, and the processor 102 is in the low power model, the WWAN handling logic may use the signal line 302 to awaken the processor 102. This is illustrated in an example in FIG. 4 regarding how the first message is handled by the WWAN module 305.

For another embodiment, when the policy indicates to the WWAN handling logic that the SMS message may require the processor 102 to perform some actions that can be delayed, and the processor 102 is in the low power mode, the WWAN module 305 may store the SMS message in a queue and not awaken the processor 102, thus maintaining the processor 102 in the low power mode. For example, the SMS messages may be stored in a memory area of the WWAN module 305. This is illustrated in an example in FIG. 4 regarding how the second message is handled by the WWAN module 305. Actions associated with the SMS messages stored in the queue may be performed by the processor 102 at a subsequent time when the processor 102 is awakened or in the normal power mode. For one embodiment, the policy may also indicate to the WWAN handling logic that certain SMS messages may be ignored, and therefore no action is to be performed by the processor 102.

In the example illustrated in FIG. 4, the recipient may be a computer system associated with an email account. When an email message is received in the email account, an SMS message may be generated and sent to the computer system 100. The email message may include certain special characteristics to distinguish it from other email messages. For example, an email message may be sent by a system support group to announce a new security system patch that needs to be installed on the computer system 100. This email message may include an email code that, when recognized, may cause an SMS message to include information to indicate that actions may need to be performed by the processor 102 with little delay. For example, the email code may be included in the subject line of the email message. The email code may simply be, for example, the phrase “urgent”. Other methods of including the email code in the email message may also be used.

One or more SMS message fields may be used to include information to indicate whether the actions to be performed by the processor 102 may or may not be delayed. One skilled in the art will recognize that the SMS message fields may include mandatory fields and optional fields. For one embodiment, one or more optional fields in the SMS message may be used. For example, these fields may include the TP_UDHI (message contains header) field and the TP_SRI (status report requested) field. For one embodiment, when the WWAN module 305 receives the SMS message, and the processor 102 is in the low power mode, the one or more SMS fields may be examined by the WWAN handling logic to determine if it is necessary to awaken the processor 102.

Referring to the security system patch example mentioned above, the system support group may send the email message at 3 in the morning with the appropriate email code to the email account associated with the computer system 100. The email may include an URL (universal resource locator) pointing to a location where the security system patch may be downloaded. The computer system 100 may be sitting on a desk somewhere. The processor 102 may be in the low power mode, and the WWAN module 305 may be active monitoring for SMS messages. In this example, the SMS message received by the WWAN module 305 may include the URL. Alternatively, the SMS message may include information relating to the URL. When the WWAN handling logic recognizes that this SMS message needs to be handled with little delay, the processor 102 is awakened. The security system patch may be downloaded to the computer system 100.

Referring to FIG. 3, the security system patch in the example described above may be downloaded using the WWAN module 305. Alternatively, when a WLAN connection is available, the security system patch may be downloaded using the WLAN module 310. Similarly, when a wired Ethernet connection is available, the security system patch may be downloaded using the Wired Ethernet module 315. When the security system patch is installed on the computer system 100, the processor 102 may go back to the low power mode. Most or all of these actions may be performed without any involvement by the user of the computer system 100. It may be noted there may be a performance difference depending on which network interface is used to download the security system patch. It may also be noted that other applications other than downloading the security system patch may also be applicable with this configuration.

Process

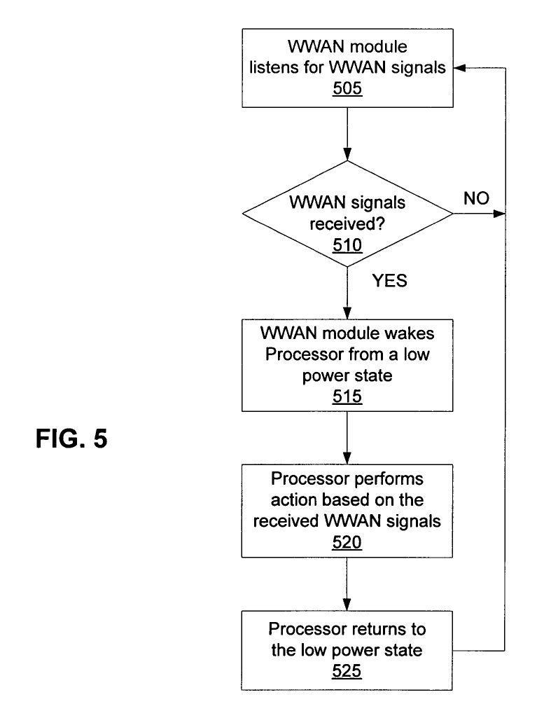

FIG. 5 is a flow diagram illustrating one example of a process that monitors for WWAN signals, in accordance with one embodiment. In this example, it is assumed that the processor 102 is currently in the low power mode. As described above, the WWAN module 305 may be normally on to allow it to continuously monitor for WWAN signals, as shown in block 505. At block 510, a test is performed to determine if one or more WWAN signals have been received. If not, the WWAN module 305 continues to monitor at block 505. When the WWAN signals have been received, the process flows to block 515 where the WWAN module 305 awakens the processor 102 using, for example, the signal line 320. The processor 102 may now be in the normal power mode. At block 520, the processor 102 performs actions based on the information included in the WWAN signals. When the actions are completed, the processor 102 may return to the low power mode, as shown in block 525. The process then continues at block 505 to monitor for new WWAN signals. Note that in this example, the processor 102 is awakened whenever new WWAN signals are received.

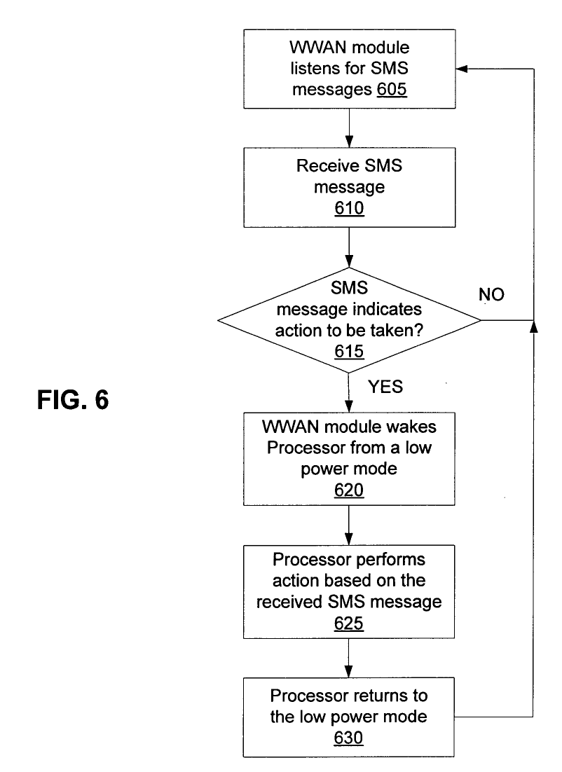

FIG. 6 is another flow diagram illustrating one example of a process that monitors for and filter SMS messages, in accordance with one embodiment. Although this example refers to SMS messages, it may also be applied broadly to WWAN signals. This example may be different from the example illustrated in FIG. 5 because the SMS messages may be filtered to determine whether it is necessary to awaken the processor 102. At block 605, the WWAN module 305 monitors for SMS messages. At block 610, the SMS messages are received from the SMSC. At block 615, a test is performed to determine if the SMS message includes information that indicates the processor 102 needs to be awakened. For example, this may be the case when the processor 102 may need to perform certain actions that may not be delayed. When the information indicates that it is not necessary to awaken the processor 102, the process flows from block 615 to block 605 to monitor for new SMS messages. It may be noted that the current SMS message may be stored for subsequent processing by the processor 102 when it is in the normal power mode.

From block 615, when it is determined that the processor 102 needs to be awakened, the processor flows to block 620. Here the WWAN module 305 may use the signal line 320 to awaken the processor 102. At block 625, the processor 102 may perform the actions based on the information included in the SMS message. The actions may include, for example, downloading the security system patch as mentioned in the example above. When the actions are completed, the processor 102 may return to the low power mode, as shown in block 630. The process may then continue at block 605 to monitor for new SMS messages.

Computer Readable Media

The techniques described may be provided as a computer program that may include a machine-readable medium having stored thereon instructions, which may be used to program a computer (or other electronic device) to perform a process according to one or more embodiments of the present invention. The machine-readable medium may include, but is not limited to, floppy diskettes, optical disks, compact disc read-only memories (CD-ROMs), and magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing instructions. Moreover, the computer program may also be downloaded, wherein the computer program may be transferred from a remote computer to a requesting computer by way of data signals embodied in a carrier wave or other propagation medium via a communication link (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A method comprising:
receiving a wireless wide area network (WWAN) signal;
filtering information included in the WWAN signal to determine if an action is to be performed by a processor; and
when the action is to be performed by the processor, and the processor is in a low power mode, determining if the processor is to be awakened.

2. The method of claim 1, wherein determining if the processor is to be awakened comprises:
determining if the action can be delayed; and
if the action cannot be delayed, awakening the processor.

3. The method of claim 2, wherein awakening the processor includes transitioning the processor from the low power mode to a normal power mode.

4. The method of claim 2, further comprising:
if the action can be delayed, queuing the WWAN signal to enable the processor to perform the action at a subsequent time when the processor is in the normal power mode.

5. The method of claim 4, wherein the WWAN signal includes short message service (SMS) message, and wherein queuing the WWAN signal includes queuing the SMS message.

6. The method of claim 1, wherein the WWAN signal is received by a normally-on WWAN module.

7. The method of claim 6, wherein the normally-on WWAN module receives power from a dedicated battery.

8. The method of claim 6, wherein the normally-on WWAN module receives power from a power source used by the processor.

9. A machine-readable medium having stored thereon data representing instructions which, when executed by a processor of an add-in module, cause the processor to perform operations comprising:
receiving a wireless wide area network (WWAN) signal;
filtering information included in the WWAN signal to determine if an action is to be performed by a processor; and
when the action is to be performed by the processor, and the processor is in a low power mode, determining if the processor is to be awakened.

10. The machine-readable medium of claim 9, wherein determining if the processor is to be awakened comprises:
determining if the action can be delayed; and
if the action cannot be delayed, awakening the processor.

11. The machine-readable medium of claim 10, wherein awakening the processor includes placing the processor in a normal power mode.

12. The machine-readable medium of claim 10, further comprising:
if the action can be delayed, queuing the WWAN signal to enable the processor to perform the action at a subsequent time when the processor is in the normal power mode.

13. The machine-readable medium of claim 12, wherein the WWAN signal includes short message service (SMS) message, and wherein queuing the WWAN signal includes queuing the SMS message.

14. A system, comprising:
a processor; and
a wireless wide area network (WWAN) module coupled to the processor, the WWAN module at least operatively responsive to receiving WWAN signals to awaken the processor when the processor is in a low power mode.

15. The system of claim 14, wherein the WWAN module is normally on.

16. The system of claim 15, wherein the WWAN module includes a dedicated battery to enable it to be normally on.

17. The system of claim 15, wherein the WWAN module receives power from a power source used by the processor.

18. The system of claim 14, further comprising:
a WWAN signal handling logic to filter the WWAN signals to determine whether to awaken the processor.

19. The system of claim 18, wherein to awaken the processor includes to transition the processor from the low power mode to a normal power mode.

20. The system of claim 18, wherein the WWAN module includes a memory to store the WWAN signals when the WWAN signal handling logic determines that the processor is not to be awakened.

21. The system of claim 20, wherein actions associated with the WWAN signals stored in the memory of the WWAN module are to be performed by the processor at a subsequent time when the processor is in the normal power mode.

22. The system of claim 14, wherein the WWAN signals include short message service (SMS) messages.

23. An apparatus, comprising:
an antenna to receive wireless wide area network (WWAN) signals;
a WWAN signal handling logic to filter the WWAN signals; and
a signal line to send wake up signal to a processor to awaken the processor from a low power mode when the WWAN signal handling logic determines that the processor is to be awakened.

24. The apparatus of claim 23, further comprising:
a power source to enable receiving the WWAN signals continuously.

25. The apparatus of claim 24, wherein the power source is a dedicated power source.

26. The apparatus of claim 24, wherein the power source is shared with the processor.

27. The apparatus of claim 23, further comprising:
a memory to store the WWAN signals when the WWAN signal handling logic determines that the processor is not to be awakened.

28. A method, comprising:
transporting WWAN signals from a source to a normally-on wireless wide area network (WWAN) module in a computer system, the WWAN module coupling to a processor and including a wakeup signal to awaken the processor from a low power mode.

29. The method of claim 28, wherein the WWAN signals include short message service (SMS) messages, and wherein transporting the WWAN signals comprises:
storing the SMS messages in a central short message center (SMC); and
forwarding the SMS messages to the WWAN module.

30. The method of claim 29, wherein the WWAN module awakens the processor from the low power mode based on information associated with the SMS messages.
